(19) United States
(12) Patent Application Publication
(10) Pub. No.: US 2005/0015490 A1
(43) Pub. Date: Jan. 20, 2005

(54) System and method for single-sign-on access to a resource via a portal server

(76) Inventors: John E. Saare, Lakeport, CA (US); Thomas R. Mueller, Fremont, NE (US)

Correspondence Address: OSHA & MAY L.L.P./SUN, 1221 MCKINNEY, SUITE 2800, HOUSTON, TX, 77010, US

(21) Appl. No.: 10/621,853

(22) Filed: Jul. 16, 2003

(51) Int. Cl. G06F 15/173

(52) U.S. Cl. 709/225

(57) ABSTRACT

A single-sign-on adapter (SSO Adapter) implementing one or more authentication mechanisms that may be used by Portal middleware on behalf of a portal user. A user seeking access to a resource server through a portal server performs a single sign-on with the portal server at the beginning of a session. When requests a resource from resource server that requires authentication, the authentication is handled by the portal server without requiring an authentication response from the user. The portal server may use stored user credentials, a token-based shared authentication service, or proxy authentication in order to gain access to the resource server on behalf of the portal user.

### RELATED UNITED STATES PATENT APPLICATIONS

This Application is related to U.S. patent application, Ser. No. ______ by Luu D. Tran, et al., filed on Jul. 14, 2003, entitled “Method and System for Storing and Retrieving Extensible Multi-Dimensional Display Property Configurations” with attorney docket no. SUN-P030063, and assigned to the assignee of the present invention.

This Application is related to U.S. patent application, Ser. No. ______ by John E. Saare and Thomas R. Mueller, filed on Jul. 14, 2003, entitled “A Method and System for Device Specific Application Optimization via a Portal Server” with attorney docket no. SUN-P030082, and assigned to the assignee of the present invention, the contents of which are incorporated herein by reference.

This Application is related to U.S. patent application, Ser. No. ______ by Sathayanarayanan N. Kavacheri and Luu D. Tran, filed on Jul. 14, 2003, entitled “Hierarchical Configuration Attribute Storage and Retrieval” with attorney docket no. SUN-P030092, and assigned to the assignee of the present invention.

### BACKGROUND OF THE INVENTION

1. Field of the Invention

This invention relates to the sign-on mechanisms used between users, portal servers, and resource servers on a network. In particular the invention relates to systems and methods for single-sign-on access of a user to a resource server through a portal server.

2. Related Art

A portal is an entry point to a set of resources that an enterprise wants to make available to the portal's users. For some consumer portals, the set of resources includes the entire World-Wide Web. For most enterprise portals, the set of resources includes information, applications, and other resources that are specific to the relationship between the user and the enterprise. For service providers, the portal provides a point of entry to customer service applications.

In general, a portal server includes a variety of software components for selecting, formatting, and transmitting information to a user. These software components may be referred to collectively as middleware.

Prior Art FIG. 1 shows a diagram 100 for conventional sign-on by user 105 seeking access to a resource through a portal server 110. Resource servers 115a, 115b and 115c are shown, with each server having respective sign-on mechanisms 121a, 121b, 121c.

The initial sign-on S1 is negotiated with the portal server 110, using the sign-on mechanism 120 that is specific to the portal server 110. After sign-on with the portal server 110, the user submits a requests to resource server 115b and negotiates a sign-on S2 with the server. Sign-on S2 is essentially passed through the portal server 110, and the user effectively carries out two independent sign-on procedures to obtain the resource 115b.

Since the sign-on mechanisms 121a, 121b, and 121c associated with servers 115a, 115b, and 115, may be different, significant overhead may be required in a conventional two-level sign-on for complete access to the resources available through the portal server 110.

For web oriented network architectures such as those based upon the Java 2 Platform, Enterprise Edition (J2EE), there is typically a general specification for connection of the network elements. For J2EE, the J2EE Connector Architecture (JCA) outlines an architecture with three main components: a resource adapter, system contracts, and a common client interface (CCI). Although the JCA provides a container-managed sign-on and a component-manages sign-on as two methods for authenticating to a resource server, the JCA does not provide a method for single-sign-on for a user accessing a resource through a portal server.

### SUMMARY OF THE INVENTION

Accordingly, there is a need for a method and system of providing a single-sign-on capability that allows a portal server to handle authentication, and other sign-on requirements of a resource server on behalf of the user accessing to the resource server through the portal server. There is also a need for a single-sign-on capability that may be shared by different software components associated with a portal server.

A single-sign-on adapter (SSO Adapter) implementing one or more authentication mechanisms that may be used by Portal middleware on behalf of a portal user is disclosed. In one embodiment, a family of Java classes is used to provide a framework for implementing a shareable collection of SSO Adapters, each of which may implement one or more authentication strategies, and which may be used by Portal middleware, on behalf of a Portal User, to gain authenticated access to information services. The single-sign-on adapter provides an abstraction layer between the user and the sign-on/authentication functions associated with connecting to a resource.

In another embodiment, the user credentials required by the resource server the portal server are stored locally on the portal server. Once the user credentials for a particular resource are stored on the portal server, any sign-on pursuant to a request by the user for that resource is handled by the portal server.

In further embodiment, a portal server implements a shared authentication service. After a user has signed on with the portal server, a request for a resource results in a session token being generated by the authentication service. The session token is an unique identifier with sufficient length to make it difficult to guess, and may also be encrypted. The portal server requests access to the requested resource server on behalf of a user by presenting the token. After validating the token with the authentication service, the resource server provides the requested resource to the user via the portal server.

In yet another embodiment, each user signs on to a portal server using a unique ID and/or password. When any user requests a resource from a resource server through the portal server, the portal signs on with that resource server using a special password that permits access to all user accounts on the resource server. The portal server maintains a registry that maps each of the individual users to the respective account identifiers, so that the user in not required to enter an identifier (provided by portal server registry), or a password (provided by portal server all accounts password). Thus, the portal server provides proxy authentication for all users.

### BRIEF DESCRIPTION OF THE DRAWINGS

The accompanying drawings, which are incorporated in and form a part of this specification, illustrate embodiments of the invention and, together with the description, serve to explain the principles of the invention:

Prior Art FIG. 1 shows a block diagram of a conventional two-level sign-on mechanism.

FIG. 2 shows a high-level diagram of a network architecture in accordance with an embodiment of the present claimed invention.

FIG. 3 shows a diagram of a system for single-sign-on through a portal server using stored credential authentication, in accordance with an embodiment of the present claimed invention.

FIG. 4 shows a diagram of a system for single-sign-on through a portal server using a token-based authentication service, in accordance with an embodiment of the present claimed invention.

FIG. 5 shows a diagram of a system for single-sign-on through a portal server using a proxy authentication service, in accordance with an embodiment of the present claimed invention.

FIG. 6 shows a diagram of a system having a portal server with a shared single-sign-on adapter, in accordance with an embodiment of the present claimed invention.

FIG. 7 shows a flow diagram for a single-sign method using stored credentials, in accordance with an embodiment of the present claimed invention.

FIG. 8 shows a flow diagram for a single-sign method using a token-based authentication service, in accordance with an embodiment of the present claimed invention.

FIG. 9 shows a flow diagram for a single-sign method using proxy authentication, in accordance with an embodiment of the present claimed invention.

### DETAILED DESCRIPTION OF THE INVENTION

In the following detailed description of the present invention, a system and method for single-sign-on ambiguity in a counter, numerous specific details are set forth in order to provide a thorough understanding of the present invention.

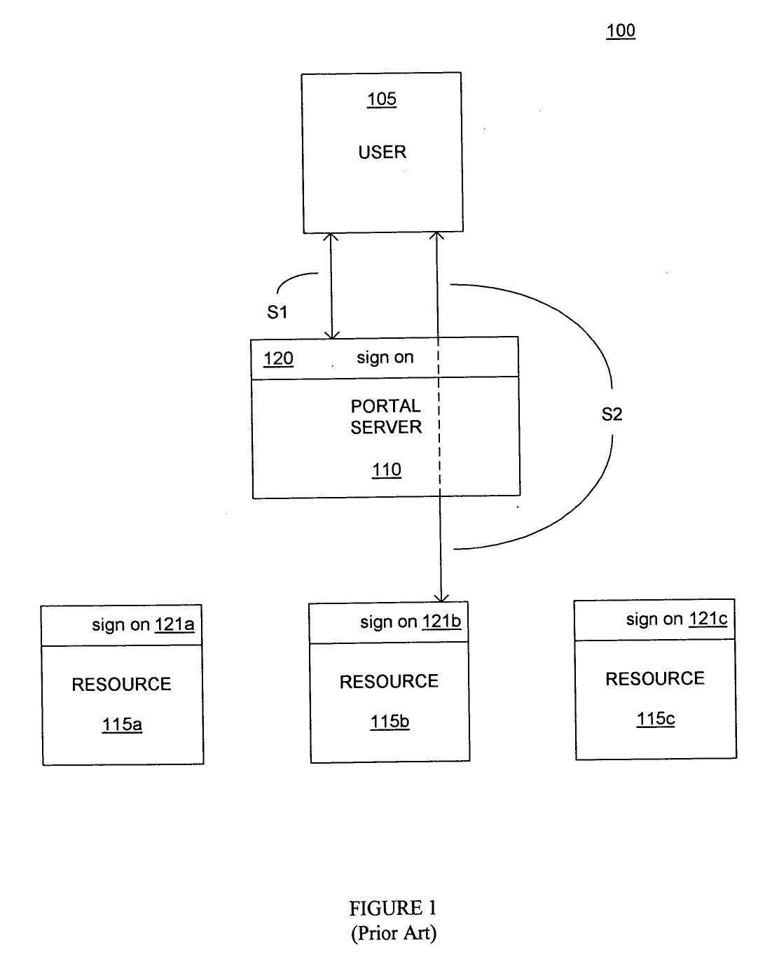

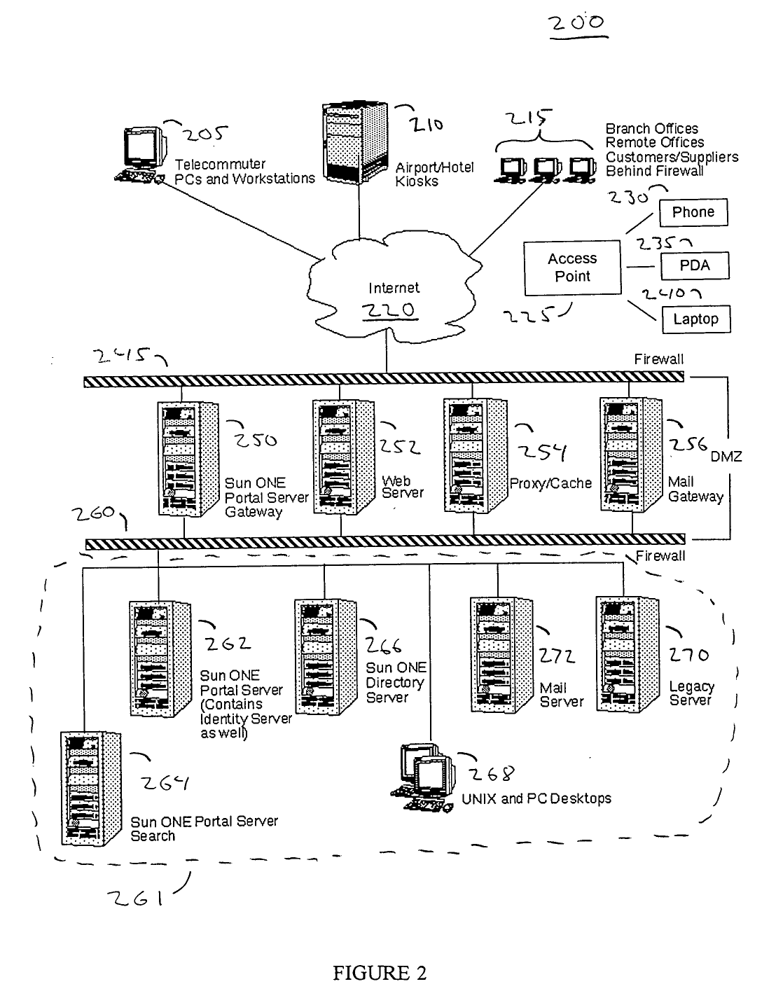

FIG. 2 shows a high-level architectural diagram 200 of a typical network installation. In this example, the gateway 250 is hosted in a demilitarized zone (DMZ) along with other systems accessible from the Internet 220, including a web server 252, proxy/cache server 254, and mail gateway 256. The core portal node 262, portal search node 264, and directory server 266, are hosted on the internal network 261 where they have access to systems and services ranging from individual employee desktop systems 268 to a legacy server 270, or a mail server 272. The DMZ is bounded by firewalls 245 and 260. In general, a network may not require all of the components shown, and may include components that are not shown.

A number of wired devices associated with users, including telecommuter PCs and workstations 205, kiosks 210, and remote terminals 215 are shown coupled to the Internet 220. In addition, a wireless access point 225 is also coupled to the internet, providing access to the wired network for users associated with wireless devices such as telephones 230, personal digital assistants (PDAs) 235 and laptop computers 240. Users on the Internet 220 typically access the gateway 250 from a web-enabled browser and connect to the gateway 250 at the IP address and port for the portal they are attempting to access. The gateway forwards requests on to the core portal node 262.

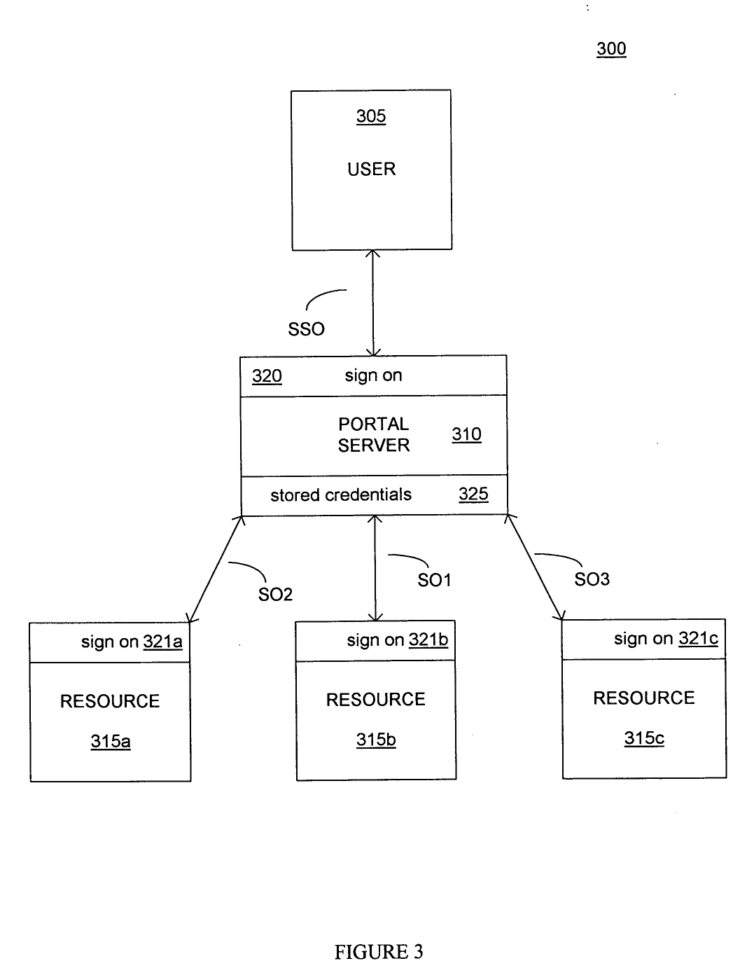

FIG. 3 shows a diagram 300 of a condensed representation of the network of FIG. 2, in accordance with an embodiment of the present invention. User 305 represents a wired or wireless user (e.g., 205, 210, 215, 230, 235, or 240 of FIG. 2), coupled to a portal server 310 (e.g., 262 of FIG. 2). Portal server 310 is in turn coupled to resources 315a, 315b, and 315c (e.g., 268, 270, and 272 of FIG. 2).

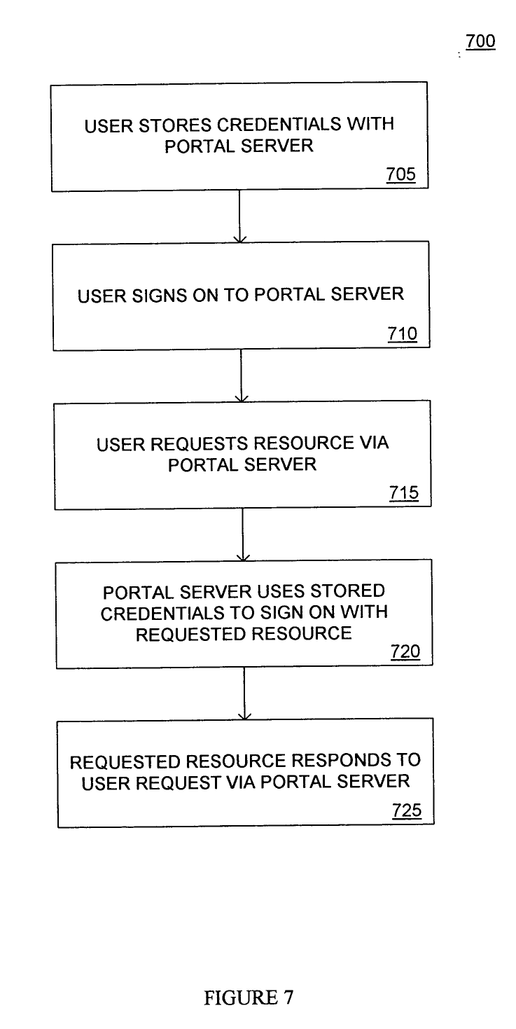

The interaction between the elements shown in FIG. 3 will be discussed with respect the flow diagram shown in FIG. 7. The Portal server 310 is provided with stored user credentials 325 (FIG. 7, step 705). The stored credentials are the same credentials that the user 305 would normally used to sign on with a resource server. The credentials may be obtained from the user by an initialization session, or they may be entered by a system administrator.

At the beginning of a session, the user 305 performs a single-sign-on SSO with the portal server 310 using the sign-on component 320 (FIG. 7, step 710). The single-sign-on SSO allows the user access to the portal server 310, with the implication that no further sign-on or authentication will be required by the user in response to subsequent requests for resources made via the portal server 310.

When a user 305 submits a request for a resource to the portal server 310 (FIG. 7, step 715), the portal server 310 uses the stored credentials to sign on with the requested resource server on behalf of the user (FIG. 7, step 720). Although the portal server may be required to sign on repeatedly to various servers during a user session, the user is only required to perform the single-sign-on at the beginning of the session.

Each of the resource servers 315a, 315b, and 315c have a respective sign-on mechanism 321a, 321b, and 321c. The sign-on mechanism for each resource server may be different, requiring unique identifiers and/or passwords, thus each of the respective sign-ons SO2, SO1, and SO3, that is conducted with sign-on mechanisms 321a, 321b, and 321c, may be different. After the portal server 310 signs one with the requested resource server, the request response is delivered to the user 305 via the portal server 310 (FIG. 7, step 725).

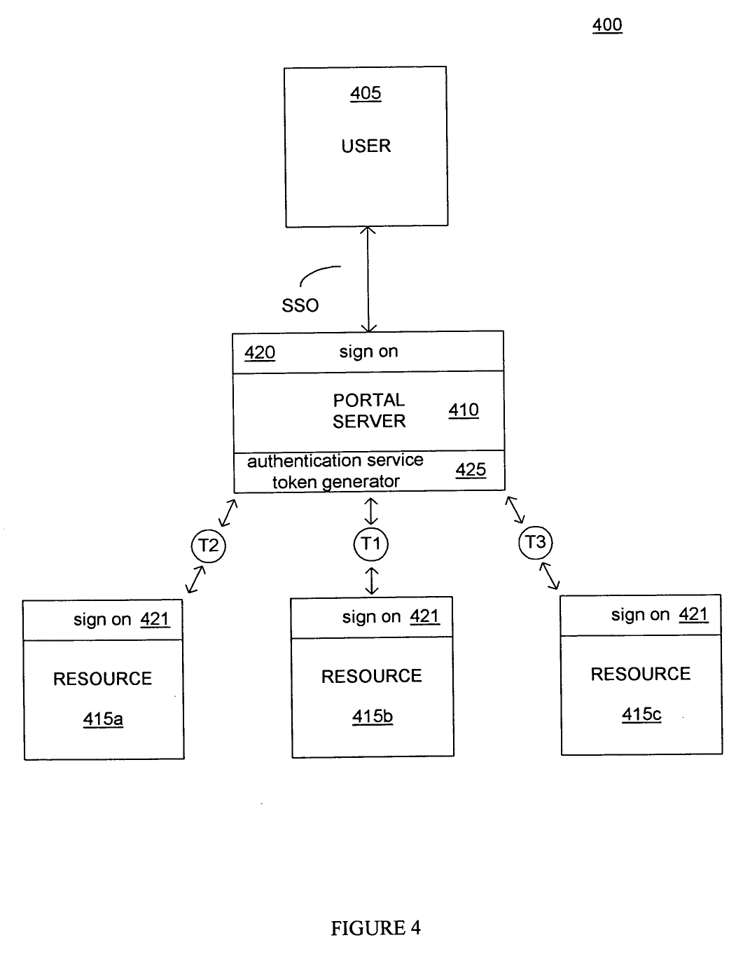

FIG. 4 shows a diagram 400 of a condensed representation of the network of FIG. 2, in accordance with an embodiment of the present invention. User 405 represents a wired or wireless user (e.g., 205, 210, 215, 230, 235, or 240 of FIG. 2), coupled to a portal server 410 (e.g., 262 of FIG. 2). Portal server 410 is in turn coupled to resources 415a, 415b, and 415c (e.g., 268, 270, and 272 of FIG. 2).

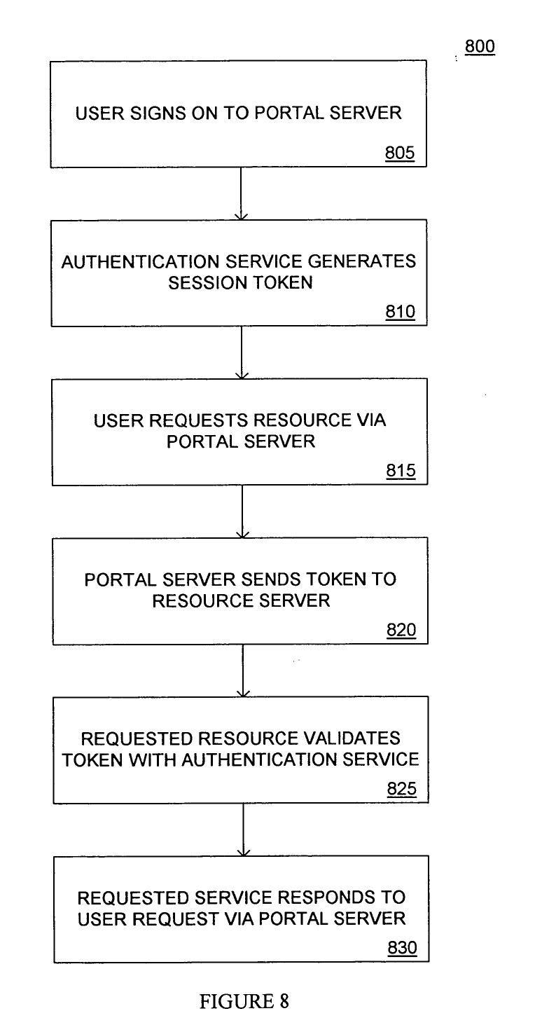

The interaction between the elements shown in FIG. 4 will be discussed with respect the flow diagram shown in FIG. 8. At the beginning of a session, the user 405 performs a single-sign-on SSO with the portal server 410 using the sign-on component 420 (FIG. 8, step 805), and a shared authentication service 425 that generates a session token (T1, T2, T3) (FIG. 8, step 810). The session token (T1, T2, T3) is a string with sufficient length to make it difficult to guess, and may also be encrypted.

When the user 405 submits a request for a resource (FIG. 8, step 815), the portal server 410 passes the token (e.g., T1) the requested resource server (e.g., 415b) (FIG. 8, step 820). Each resource server has a sign-on mechanism 421 that handles the token received from the portal server 410. Upon receipt of the token T1, resource 415b validates the token with the authentication service 425, using the sign-on mechanism 421 (FIG. 8, step 825). Once the token T1 is validated, the resource server 415b responds to the user request via the portal server 410 (FIG. 8, step 830).

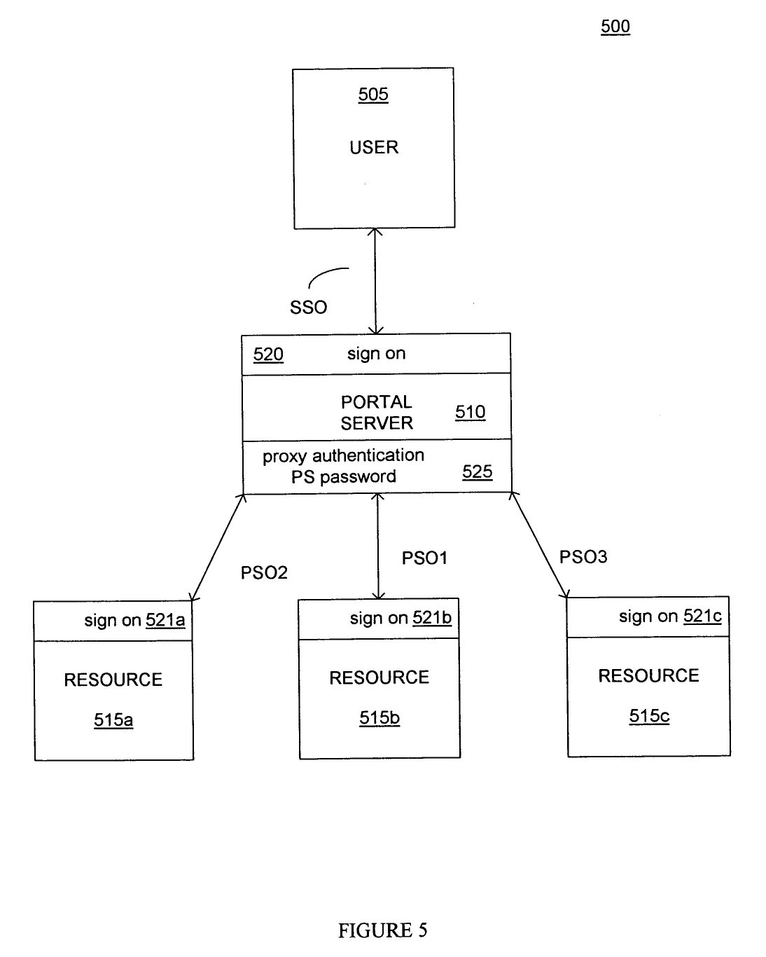

FIG. 5 shows a diagram 500 of a condensed representation of the network of FIG. 2, in accordance with an embodiment of the present invention. User 505 represents a wired or wireless user (e.g., 205, 210, 215, 230, 235, or 240 of FIG. 2), coupled to a portal server 510 (e.g., 262 of FIG. 2). Portal server 510 is in turn coupled to resources 515a, 515b, and 515c (e.g., 268, 270, and 272 of FIG. 2).

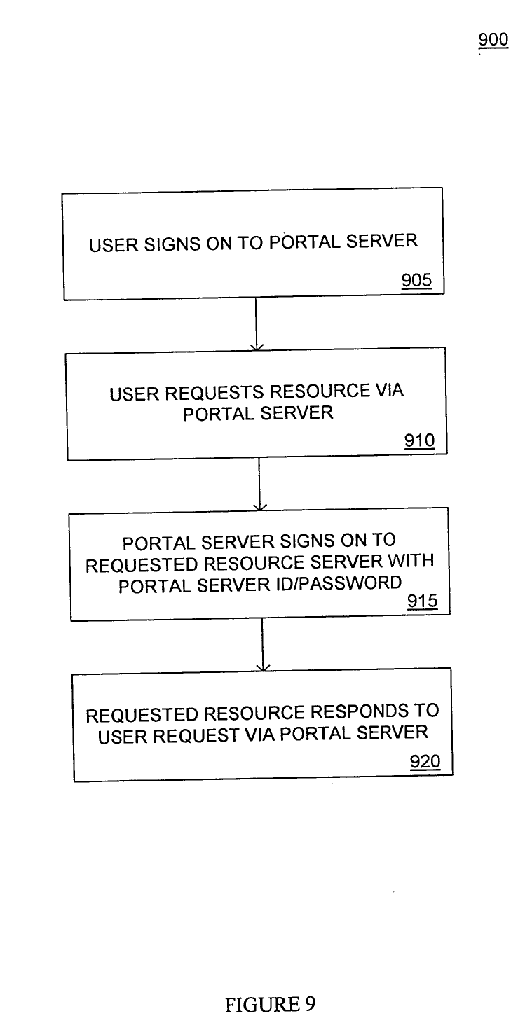

The interaction between the elements shown in FIG. 5 will be discussed with respect the flow diagram shown in FIG. 9. At the beginning of a session, the user 505 performs a single-sign-on SSO with the portal server 510 using the sign-on component 520 (FIG. 9, step 905).

Each resource server 515a, 515b, and 515c has a respective sign-on component 521a, 521b, and 521c. When the user 505 requests a resource (515a, 515b, or 515c) (FIG. 9, step 910), The proxy authentication component 525 associated with the portal server 510 sends an ID/password PSO2, PSO1, or PSO3, to the requested server, 515a, 515b, or 515c, respectively (FIG. 9, step 915). After the portal server has signed on using it s ID/password, the requested resource is returned to the user 505 via the portal server 510 (FIG. 9, step 920).

The sign-on component associated with each resource server may be different, thus requiring a different ID/password from the portal server 510. The portal server ID/password grants the portal server 510 access to all user accounts on a given resource server. Thus, the portal server authenticates for all users with respect to a given resource server using a single ID/password.

For resources that have user accounts that must be distinguished (e.g. email), the portal server maintains a registry that maps the portal user with the local resource account, thus allowing the portal server to access the account without the user entering an account identifier.

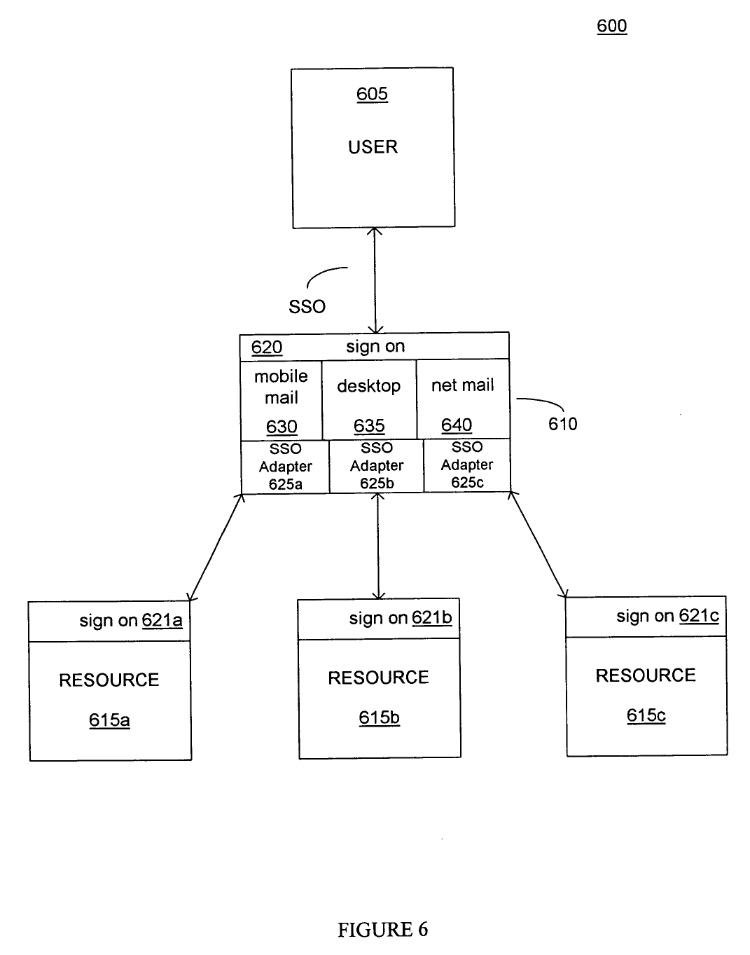

FIG. 6 shows a diagram 600 of a condensed representation of the network of FIG. 2, in accordance with an embodiment of the present invention. User 605 represents a wired or wireless user (e.g., 205, 210, 215, 230, 235, or 240 of FIG. 2), coupled to a portal server 610 (e.g., 262 of FIG. 2). Portal server 610 is in turn coupled to resources 515a, 515b, and 515c (e.g., 268, 270, and 272 of FIG. 2).

Portal server 610 provides a mobile mail service 630, a desktop service 635, and a netmail service 640. Each service within the portal server 610 may require access to a resource (615a, 615b, 615c). The portal server 610 includes SSO adapters 625a, 625b, and 625c, that are associated with sign-on mechanisms 621a, 621b, and 621c, respectively.

Each of the SSO adapters is shared by the services 630, 635, and 640, eliminating the need for each service to have its own adapter. A given SSO adapter and associated sign-on mechanism may use stored credential sign-on, shared authorization sign-on, or proxy authorization as previously described. Examples of resources that may be accessed are email, instant messaging, calendar, and addressbook servers.

While the present invention has been described in particular embodiments, it should be appreciated that the present invention should not be construed as limited by such embodiments, but rather construed according to the below claims.

1. A method for providing a portal user access to a resource server via a portal server, comprising:
said portal user performing a single-sign-on to access said portal server;
said portal user requesting a resource from said resource server via said portal server;
said portal server performing a sign-on to access said resource server on behalf of said portal user; and
said resource server returning said resource to said portal user via said portal server.

2. The method of claim 1, wherein said performing a sign-on to access said resource server comprises a using stored credentials.

3. The method of claim 1, wherein said performing a sign-on to access said resource server comprises using a shared authentication service.

4. The method of claim 1, wherein said performing a sign-on to access said resource server comprises using proxy authentication.

5. The method of claim 1, wherein said resource server is an electronic mail server.

6. The method of claim 1, wherein said resource server is an instant messaging server.

7. The method of claim 1, wherein said resource server is an addressbook server.

8. The method of claim 1, wherein said resource server is a calendar server.

9. A system for providing a portal user access to a resource server via a portal server using a single-sign-on, said system comprising
a first sign-on mechanism associated with said portal server for allowing said portal user access to said portal server;
a second sign-on mechanism associated with said portal server for allowing said portal server access to said resource server; and
wherein said first sign-on mechanism is executed only once during a user session, and wherein said second sign-on mechanism is executed one or more times.

10. The system of claim 9, wherein said second sign-on mechanism comprises stored credential sign-on.

11. The system of claim 9, wherein said second sign-on mechanism comprises a shared authentication service.

12. The system of claim 9, wherein said second sign-on mechanism comprises a proxy authentication service.

13. The system of claim 9, wherein said resource server is an electronic mail server.

14. The system of claim 9, wherein said resource server is an instant messaging server.

15. The system of claim 9, wherein said resource server is an addressbook server.

16. The system of claim 9, wherein said resource server is a calendar server.

17. A computer readable medium containing executable instructions which, when executed in a system comprising a portal server coupled to a resource server, causes the system to provide a resource to a portal, comprising:
performing a first sign-on on behalf of said portal user with said portal server using a single-sign-on;
receiving a request for said resource from said portal user;
performing a second sign-on by said portal server to access said resource server on behalf of said portal user; and
returning said resource to said portal user via said portal server.

18. The computer readable medium of claim 17, wherein said performing a second sign-on to access said resource server comprises using stored credentials.

19. The computer readable medium of claim 17, wherein said performing a second sign-on to access said resource server comprises using a shared authentication service.

20. The computer readable medium of claim 17, wherein said performing a second sign-on to access said resource server comprises using proxy authentication.
